(19) United States
(12) Patent Application Publication
(10) Pub. No.: US 2016/0191482 A1
(43) Pub. Date: Jun. 30, 2016

(54) SYSTEM AND METHOD FOR PROVIDING AUTHENTICATED COMMUNICATIONS FROM A REMOTE DEVICE TO A LOCAL DEVICE

(71) Applicant: Cyanogen Inc., Palo Alto, CA (US)

(72) Inventors: Jeremy Truelove, Seattle, WA (US); Les Prock, Edgewood, WA (US); Chris Soyars, Seattle, WA (US)

(21) Appl. No.: 14/588,330

(22) Filed: Dec. 31, 2014

(51) Int. Cl. H04L 29/06

(52) U.S. Cl. CPC H04L 63/08; H04L 63/123

(57) ABSTRACT

A method and system for enabling authenticated communications between a local device and a remote device over a network. An authentication service verifies user credentials and transmits an identity token to the local device. The local device transmits the identity token to the device manager, and receives an associated channel identifier for a device specific channel. The local device transmits to the device message relay a request to receive data on the device specific channel. The local device listens for approval on an approval channel and transmits to the device message relay the channel identifier and the identity token. The device message relay transmits an approval via the approval channel if the identity token is authentic and the user has permission to receive data on the device specific channel. Data from the remote device can be transmitted via the device specific channel.

### BACKGROUND

A user physically separated from a mobile device may wish to be transmitted data from the device. For example, having lost a mobile device, a user may desire for the device to transmit live geographic coordinates for the device so that the device may be tracked. It is important for systems that enable a user to remotely access data from a device to ensure that the user is properly authenticated before data from the remote device is transmitted to the user at another device.

Web browsers and other web-interfacing applications can establish a connection with a remote device for receiving communications. For example, a web browser can establish a WebSocket connection with a remote device for full-duplex communications. If a web browser of a local device were to connect directly to a remote device, the remote device could use standard authentication procedures to verify that a user at the local device is who the user claims to be. However, in practice, it is unlikely that a network interfacing application can connect directly to a remote device. Intermediary services must facilitate communication, and authentication protocols adequate for direct communication may not be feasible or secure.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which a system for enabling authenticated communications between two devices over a network may operate.

FIG. 2 is a diagram of components of a system for enabling authenticated communications between two devices over a network.

FIG. 3 is a messaging diagram depicting messages transmitted among devices and system components for enabling authenticated communications between the devices.

FIG. 4 is flow diagram depicting steps performed by the system for establishing authenticated communications between a remote device and a local device.

### DETAILED DESCRIPTION

A method and system are described for enabling authenticated communications between two devices over a network. A user is authenticated via an authentication protocol, which the system commences after receiving a request by the user via a local device for data from a remote device. The system authenticates a user of the local device prior to causing the remote device to transmit data to a web browser or another network-interfacing application of the local device. The system can establish authenticated communications for a number of applications, including for transmitting geographical information of a lost remote device to the local device, so that a user may find the lost device. The authentication protocol ensures that the user at the local device is permitted to receive data on a communications channel associated with the remote device before data is transmitted to the local device via that channel. The communications channel can be, for example, a WebSocket channel.

The system comprises an authentication service, a device manager, and a device message relay. The authentication service receives from the local device login credentials, such as a username and a password, which may be received by the local device from a user via a network interfacing application, such as a web browser. The authentication service verifies the validity of the received credentials and transmits to the network interfacing application an identity token if the login credentials are valid. The network interfacing application of the local device receives data from the remote device via the device message relay, and the network interfacing application receives the data from the device message relay via a channel associated with the remote device. The channel can be associated with an identifier that is supplied to the network interfacing application by the device manager. For example, the network interfacing application may transmit the identity token received from the authentication service to the device manager, and the device manager may present the identity token to the authentication service, which provides a user identifier associated with the identity token. The device manager may transmit the user identifier, which is to be used as the identifier for the channel, to the network interfacing application. The device manager can identify a channel identifier in other ways. In some implementations, the device manager maintains a mapping of software-generated channels and associated users, and it identifies a channel identifier based on a received user identifier. The user identifier may be received from the network interfacing application, or the device manager may present the identity token to the authentication service, which provides a user identifier associated with the identity token.

The network interfacing application transmits a request to the device message relay to receive data from the remote device on a channel associated with the channel identifier. For example, the network interfacing application of the local device can transmit a registration request to the device message relay, and the device message relay may permit the network interfacing application to listen on an approval channel. The network interfacing application may listen on the approval channel and transmit to the device message relay a verification request, including the identity token received from the authorization service and the channel identifier received from the device manager. The device message relay verifies with the device manager whether the user is authorized to access the channel associated with the channel identifier. The device message relay transmits the identity token to the authentication service, which can confirm whether the identity token is valid. The identity token may be transmitted to the device manager, which transmits the token to the authentication service. The device manager confirms that the user is associated with the channel identifier and permitted to access data on the channel. After verifying the authenticity of the identity token and ensuring that the user is permitted to listen on the channel associated with the channel identifier, the device message relay transmits an approval to the local device via the approval channel. After transmitting the approval, the device message relay adds the connection with the network interfacing application to the channel associated with the channel identifier, and the local device subscribes to that channel. The device manager can request that the remote device transmit data. The local device may thereafter receive data transmitted by the remote device via the device manager and device message relay, transmitted from the device message relay to the local device via the channel associated with the channel identifier.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for providing authenticated communications between a remote device and a local device. The system is described with respect to a number of processes that it may implement and numerous examples of how it may be implemented.

### Suitable Environments

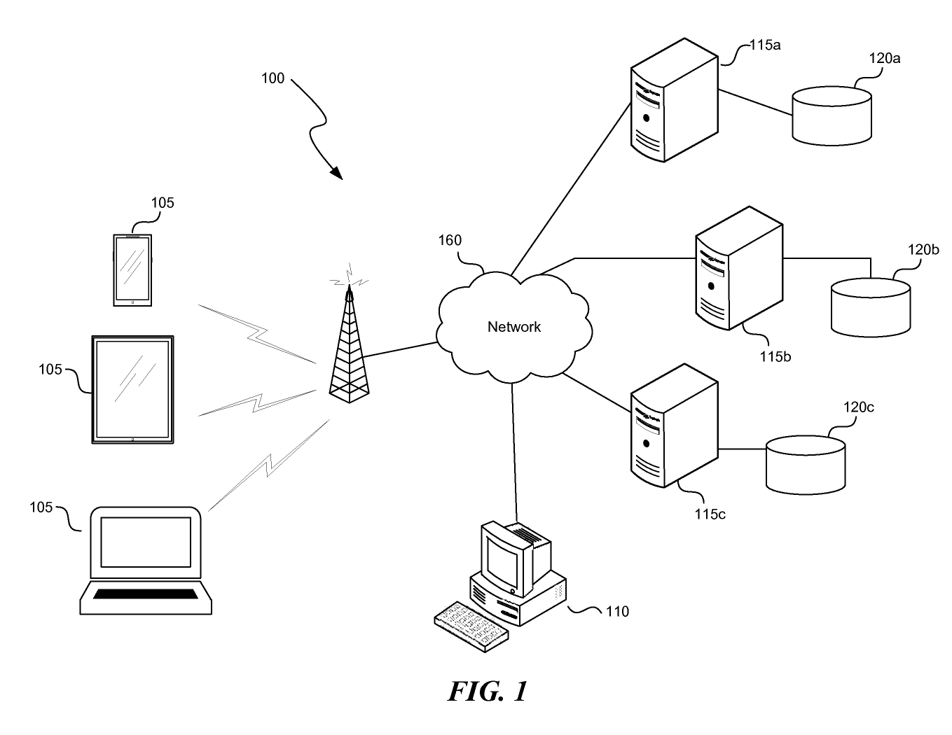

FIG. 1 and the following discussion provide a brief, general description of a suitable computing environment 100 in which a system for enabling authenticated communications may be implemented. Although not required, aspects and implementations of the invention will be described in the general context of computer-executable instructions, such as routines executed by a general-purpose computer, a server computer, or other computing systems and devices. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, and stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a system for providing authenticated communications between a remote device and a local device according to embodiments of the invention operates in or among server computers 115a-c for providing authenticated communications between mobile devices 105, between mobile devices and personal computer 110, or between two other computing devices. The system may also be implemented to enable authenticated communications between computing devices including a set top box, a smart appliance, a navigation system, digital camera, or the like. The mobile devices 105, wearable devices 108, and personal computers 110 communicate through one or more wired or wireless networks 160 with the servers 115. Data storage areas 120a-c contain data utilized by the system, and, in some implementations, software necessary to perform functions of the system. For example, the data storage area 120a may contain a mapping for a device manager linking user identifiers and software-generated channel identifiers.

The mobile devices 105 and computer 110 communicate with each other and servers 115a-c through networks 160, including, for example, the Internet. The mobile devices 105 communicate wirelessly with a base station or access point using a wireless mobile telephone standard, such as the Global System for Mobile Communications (GSM), or another wireless standard, such as IEEE 802.11, and the base station or access point communicates with the servers 115a-c via the networks 160. Computers 110 communicate through the networks 160 using, for example, TCP/IP protocols, including, for example, the WebSocket protocol.

### Suitable Systems

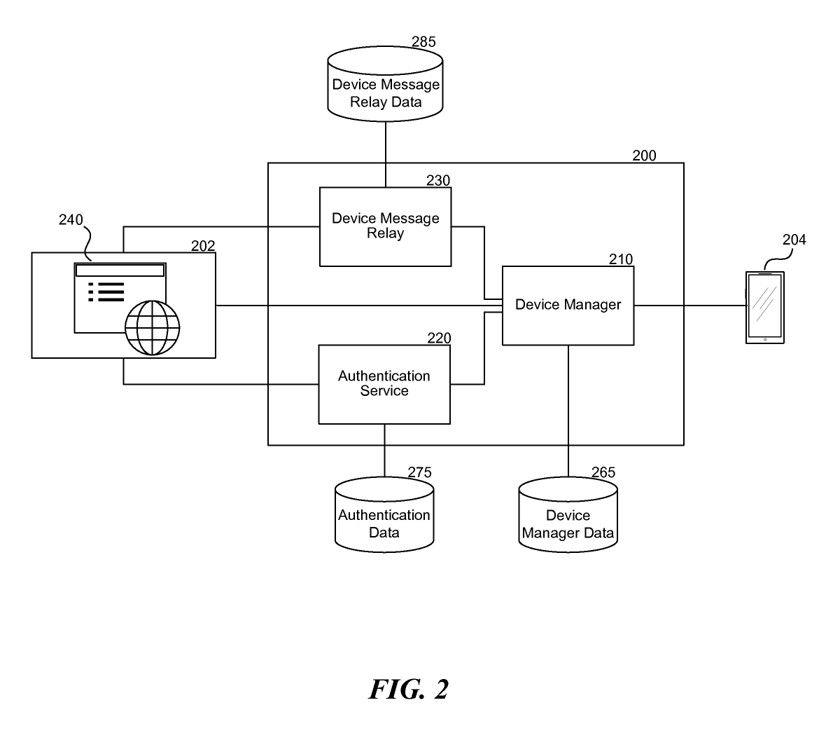

FIG. 2 is a block diagram of a system 200 for providing for authenticated communications between a remote device 204 and a local device 202. The remote device may be, for example, one of the mobile devices 105, and the local device may be, for example, the personal computer 110. A network interfacing application is executed by the local device. The network interfacing application of FIG. 2 is a web browser 240, and it displays a web page on the local device 202. The system includes a device manager 210, an authentication service 220, and a device message relay 230. The device manager accesses data contained in device manager data storage 265, the authentication service 220 accesses data contained in authentication data storage 275, and the device message relay accesses data contained in device message relay data storage 285. The device manager 210, authentication service 220, and device message relay 230 can be implemented in separate computing systems. For example, each could be implemented in one of the server computers 115a-c. Alternatively, the device manager, authentication service, and device message relay can be implemented in one or two computing devices, each distributed among multiple computing devices, or the like.

The device manager 210 identifies a channel for transmitting data from the device message relay 230 to the web browser 240 and verifies that a user is permitted to receive data on that channel. The device manager identifies a channel identifier for receiving data from the remote device and transmits the channel identifier to the network interfacing application. In some implementations, the channel identifier is a user identifier. For example, the device manager is configured to receive an identity token from a network interfacing application of a local device, transmit the identity token to the authorization service, and receive a user identifier from the authorization service, which it transmits to the network interfacing application for use as a channel identifier. In some implementations, a channel identifier is identified based on a received user identifier. For example, the device manager may maintain in device manager data storage 265 a channel-user mapping, which may be a table associating software-generated channels and user identifiers for users approved to receive data on those respective software-generated channels. The device manager 210 may identify a channel identifier for receiving data from the remote device in the mapping. For example, the device manager may receive a user identifier from the web browser 240 and identify a channel identifier associated with the user identifier. The device manager identifies a channel identifier associated in the mapping with the user identifier and transmits the associated channel identifier to the web browser. The user identifier, used for identifying the channel identifier in the mapping may, may also be determined by presenting the identity token to the authentication service

The device manager may subsequently verify that a user is permitted to receive data on a channel associated with a channel identifier. The device manager is configured to receive from the device message relay 230 a channel identifier and a user identifier and determine whether the channel and user identifiers are associated with each other in the channel-user mapping. For example, the device manager may compare the received user identifier and channel identifier to user identifiers and channel identifiers in the mapping, and it may determine that the user is permitted to receive data on the channel associated with the channel identifier if the identifiers are associated with one another in the mapping. Thus, the device manager ensures that a user associated with the user identifier is authorized to receive data via the channel associated with the channel identifier. The device manager 210 is configured to transmit to the device message relay an indication that the user associated with the user identifier is permitted to receive data on the device-specific channel associated with the channel identifier. In some implementations, the device manager verifies that a user is permitted to receive data on a channel associated with a channel identifier when an identity token for the user is determined to be valid and a received channel identifier is recognized by the device manager.

Device manager data storage 265 contains data related to channel identifiers and associated users. For example, the device manager may maintain a channel user mapping in device manager data storage. The device manager 210 can create the channel-user mapping, or it may receive the mapping from another service or system. For example, the channel-user mapping can be copied in its entirety from another service or system to the device manager data storage area 265. In some implementations, the device manager creates and thereafter modifies the channel-user mapping as it receives instructions to add or remove users from the mapping or to associate a channel with a user. In some implementations, the device manager receives user identifiers from another system or service and assigns a channel identifier to each received user identifier. For example, the device manager 210 may receive a user identifier from the authentication service 220 as a user account is created. A channel identifier is associated with a software-generated channel for transmitting data to a local device. In some implementations, the channel-user mapping includes a listing of user identifiers associated with users who are permitted to receive data from a respective remote device. Device manager data storage 265 may also contain data associated with remote devices, including data enabling the device manager to request data from the remote devices. For example, device manager data storage may include device identifiers for remote devices, including, for example, a phone number, an IP address, or an IMEI. The device manager may also store instructions for requesting data from the remote devices.

After a user is approved for receiving data on a software-generated channel and properly authenticated, the device manager 210 transmits a request to the remote device 204 for the remote device to transmit data that can be relayed to the web browser 240. In some implementations, data transmitted by the remote device is transmitted from the remote device to the device manager and then to the device message relay before being transmitted to the web browser 240. In some implementations, the remote device transmits data directly to the device message relay, which transmits the data to the web browser 240.

The authentication service 220 receives user credentials, compares the received user credentials to stored user credentials, and outputs an identity token if the received user credentials match stored user credentials. Authentication data storage 275 contains stored user credentials that are compared against received credentials. The stored user credentials are for users respectively associated with computing devices from which the system 200 may provide authenticated communications from a remote device to a local device. For example, stored credentials may include usernames and passwords of users of a remote location determination service operating on mobile devices. In some implementations, the received user credentials and/or the stored user credentials are encrypted, and the authentication service 220 is configured to compare encrypted user credentials.

The authentication service 220 generates an identity token associated with the received credentials. The identity token can be used for authenticating the user. In some implementations, an identity token is a random number generated by the authentication service. An identity token can be generated when an account associated with the user is first created. In some implementations, an identity token is generated when user credentials are validated. In some implementations, the identity token is an OAuth token. In some implementations, the identity token includes a cryptographic hash value generated using a cryptographic hash function. For example, the authentication service may use as input to a hash function used for generating identity tokens a random number that it stores in association with the username, and the resulting hash value is the identity token. After an identity token is created, the authentication service transmits the token to the web browser 240.

The authentication service 220 is configured to verify the validity of a received identity token. The authentication service 220 may receive a request by the device manager 210 to verify the authenticity of an identity token, which has been received from the web browser 240 via the device message relay 230. For example, the web browser may request to receive data via a device-specific channel, and include in the request an identity token and a username. In some implementations, the authentication service communicates directly with the device message relay 230. As mentioned above, in some implementations the identity token is a cryptographic hash value. The authentication service 220 can verify the validity of the cryptographic hash value (i.e., the identity token) by comparing the received hash value to a hash value generated using a cryptographic hash function used for generating identity token. The input for the cryptographic hash function includes the input used previously to generate the identity token, such as a random number stored in association with the received username. In some implementations, the identity token is a random number, and the authentication service compares the random number to a stored random number. The authentication service 220 is also configured to identify a user identifier based on a received identity token. For example, the authentication service 220 may compare a received identity token to stored identity tokens, and identify a user identifier associated with a matching identity token of the stored identity tokens.

The device message relay 230 is configured to receive a request by the web browser 240 for data from the remote device and to establish a connection with the web browser for transmitting data from the remote device via a software-generated channel associated with the remote device 204. The request includes the identity token received by the browser from the authentication service 220 and the channel identifier received by the browser from the device manager 210. The device message relay is configured to identify parameters for establishing the connection with the browser via the software-generated channel associated with the channel identifier. For example, based on the channel identifier, the device message relay may identify in a lookup table stored in device message relay data 285 parameters for establishing a WebSocket connection with the browser.

The device message relay 230 relays data received from the remote device 204 to the web browser 240. The data may be transmitted in discrete messages. In some implementations, the data is transmitted via the device manager. The software-generated channel may be a WebSocket channel. The device message relay also is configured to transmit data to the web browser 240 via an approval channel. The approval channel can be a WebSocket channel that broadcasts to the web browser 240 an approval of a user for receiving data via the device-specific software-generated channel. The approval can include data for establishing a connection and receiving data via the channel associated with the remote device 204. For example, the device message relay can transmit to the web browser, via the approval channel, parameters for establishing a WebSocket connection via the channel for receiving data from the remote device. The device message relay 230 is configured to add a socket already established with the browser to the channel for receiving data from the remote device, and the browser may subscribe to that channel to receive data from the remote device. The device message relay is configured to disconnect a WebSocket connection if a user is unauthorized to receive data from the remote device.

The web browser 240, device message relay 230, device manager 210, authentication service 220, and remote device 204 can communicate via encrypted messages. In some implementations, a message sent from the web browser 240 to the authorization service 220 is a REST message. In some implementations, a message transmitted by the device message relay to the device manager is a REST message. Likewise, a message transmitted by the device manager to the device message relay is can be a REST message. In some implementations, a message transmitted from the device manager 210 to the authorization service 220 is a REST message. In some implementations, a message transmitted from the web browser to the device manager is a REST message. A message transmitted from the device manager 210 to the remote device 204 can be a push message. A message transmitted from the remote device to the device manager can be a REST message.

The system 200 can be used for establishing authenticated communications for various applications. In some implementations, the system 200 facilitates authenticated communications for remotely deleting data on a remote device. In some implementations, the system 200 facilitates authenticated communications for messaging between a web browser and a remote device. The system can facilitate authenticated communications for many other applications, including, as mentioned above, for transmitting geographic location information for locating a missing device.

### Example Processes

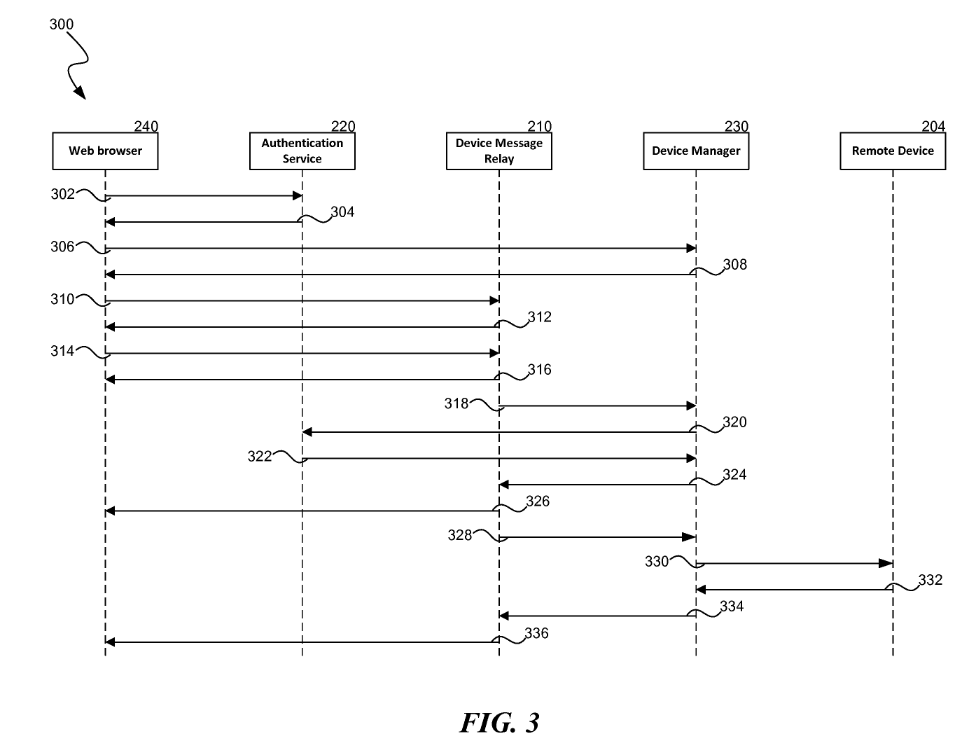

FIG. 3 is a messaging diagram 300 showing messaging among the web browser 240 operating on the local device 202, the device manager 210, the authentication service 220, the device message relay 230, and the remote device 204, for securing web-based authenticated communications between the remote device and the local device. The messaging diagram 300 shows representative messages transmitted among these components. In some implementations, messages in addition to those depicted or described with respect to the messaging diagram 300 are exchanged among the components, or messages are transmitted in a different order than the order shown in and described with respect to the messaging diagram 300.

The system 200 commences a protocol for providing authenticated communications after receiving from the local device a request for data from the remote device 204. The request is received at the local device by the web browser 240, and can be received from a user via a webpage displayed by the browser. The request includes user credentials, such as a username and a password. The request can also identify data desired from the remote device. For example, a request for data from a mobile device may be received from a user by a webpage for requesting and receiving location information for the mobile device, and the request may include that the mobile device send geographic coordinates, as determined by the mobile device. In some implementations, the request for data includes a request to delete and/or modify data stored by the remote device.

At a message 302, the web browser transmits a login request including the received user credentials to the authentication service 220. The request may be included in a REST message. The authentication service 220 verifies the validity of the received credentials and, if they are valid, generates an identity token. The identity token may include, for example, an encrypted identifier associated with the user or hash of input including a user identifier. At a message 304, the authentication service transmits to the web browser 240 the identity token. At a message 306, the web browser 240 transmits a request to the device manager 210 for a device-unique channel identifier associated with the remote device. The request may include a user identifier, such as a username, which may be received by the browser from the user. The request may be included in a REST message. In some implementations, the request does not include a user identifier, and instead includes the identity token received from the authentication service 220.

The device manager 210 identifies a channel identifier associated with a channel for receiving data from the remote device. The device manager can compare the received user identifier with user identifiers of a channel-user mapping. The channel-user mapping correlates user identifiers and software generated channel identifiers. For example, the device manager may compare a received username with usernames included in a table that maps usernames and channel identifiers. If it does not identify the received user identifier in the channel-user mapping, the device manager can send a message to the local device indicating that the user was not identified. In some implementations, the device manager does not receive a user identifier from the browser but does receive an identity token. The device manager may request a user identifier associated with the received identity token from the authentication service. The authentication service can identify a user identifier associated with the token and transmit the user identifier to the device manager. In some implementations, the device manager compares the user identifier to a list of user identifiers associated with remote devices from which data may be requested. If it does identify the received user identifier in the channel-user mapping or in the list of approved user identifiers, the device manager, at a message 308, transmits a response to the local device including the channel identifier. In some implementations, the user identifier received from the authentication service is used as the channel identifier and transmitted to the local device.

At a message 310, the web browser transmits a request to register with the device message relay 230 on a channel associated with the channel identifier received from the device manager. The channel can be a WebSocket channel, and the request to register can be a verification request. The request includes the channel identifier received from the device manager and the identity token received from the authentication service. A user identifier can also be included in the request. The identity token can be included in the body of the request message transmitted by the web browser. At a message 312, the device message relay transmits a message to the web browser indicating that it may listen on an approval channel. At a message 314, the web browser 240 transmits to the device message relay 230 a request to listen on the approval channel. At a message 316, the device message relay transmits data on the approval channel, which the web browser listens to. In some implementations, the web browser requests to listen on an approval channel prior to transmitting a request to register on the channel associated with the channel identifier. In some implementations, a request by the web browser to register on a channel associated with the channel identifier includes a request to listen on an approval channel, and the web browser automatically listens on the approval channel if the device message relay permits it to.

The device message relay 230 verifies whether the user is permitted to receive data on the device-specific channel. At a message 318, the device message relay 210 transmits to the device manager 210 the identity token and the channel identifier received from the web browser 240. In some implementations, the user identifier is transmitted as well. The device manager 210 determines whether the user is permitted to receive data on the channel associated with the received channel identifier. In some implementations, the channel identifier is a user identifier, and the device manager compares the user identifier to a list of user identifiers associated with respective devices that they are permitted to receive data from, determining that a user associated with a received user identifier is permitted to receive data on a device specific channel associated with the user identifier and included in the list. In some implementations, the device manager compares a received user identifier with user identifiers from a channel-user mapping, and, for a matching user identifier, compares an associated channel identifier with the received channel identifier.

The device manager can rely on the authentication service for verifying the authenticity of the identity token. At a message 320, the device manager 210 transmits the identity token to the authentication service 220. The device manager can transmit the identity token in a REST message. The authentication service determines whether the identity token is valid. In some implementations, the authentication service verifies the validity of the identity token by decrypting it and comparing the decrypted identity token to stored identity information associated with the user. In some implementations, the identity token is a cryptographic hash value, and the authentication service determines its authenticity by generating a hash value using a cryptographic hash function having as input the input used for generating the identity token. If the identity token is determined to be authentic, the authentication service can confirm that the identity token is valid. At a message 322, the authentication service transmits to the device manager 210 an indication of whether the received identity token is valid.

After verifying that the user is permitted to receive data on the device-specific channel and receiving an indication from the authorization service that the identity token is valid, at a message 324, the device manager transmits an indication to the device message relay that the user is verified. For example, the device manager may transmit a REST message indicating that the user is verified. At a message 326, the device message relay 230 transmits an indication to the web browser via the approval channel indicating that the web browser can listen for and receive data on the device-specific channel. The device message relay 230 can register the web browser on the device-specific channel associated with the received channel identifier. For example, the web browser and device message relay may enter into a registration process for enabling the web browser to listen on the device-specific channel. The web browser thereafter subscribes on the device-specific channel with the device message relay. In some implementations, the device message relay adds the socket established with the local device to the device-specific channel, and the local device subscribes to it.

After registering the web browser on the device-specific channel, the device message relay requests data from the remote device 204. At a message 328, the device message relay 230 requests for the device manager 210 to transmit a request to the remote device 204 for transmitting data. The message identifies the data for the remote device to transmit. At a message 330, the device manager relays the request for data to the remote device. The message may be a push message. At a message 332, the remote device transmits data to the device manager. At a message 334, the device manager relays the transmitted data to the device message relay. At a message 336, the device message relay transmits the data over the device-specific channel to the web browser.

During messaging for establishing authenticated communications, a user may be denied or disconnected by the system. For example, if user credentials are not valid, if an identity token cannot be authenticated, or if user credentials are not associated with a device specific channel, the system may disconnect the user. In some implementations, if a network interfacing application attempts to subscribe on a device-specific channel prior to being approved, the device message relay automatically disconnects the network interfacing application.

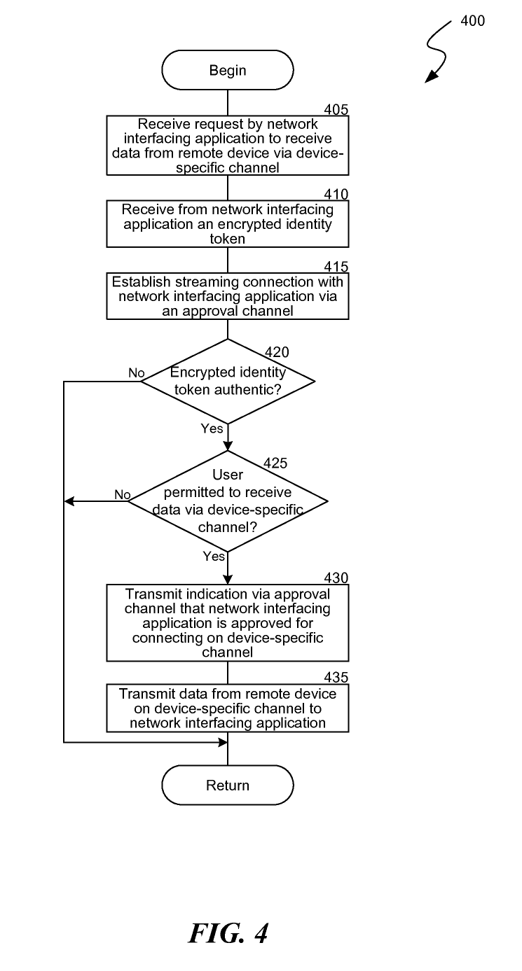

FIG. 4 is a flow diagram representing a process 400 performed by the system 200 for enabling authenticated communications between a remote device and a local device. At a block 405, the system receives from a network interfacing application of the local device a request to receive data from the remote device via a device-specific channel associated with a channel identifier. In some implementations, the channel identifier is a user identifier that has been identified, by the device manager and the authentication service, as being associated with an identity token.

At a block 410, the system 200 receives from the web interfacing application an identity token. The identity token is generated by the authentication service, and the web interfacing application may have received the identity token after user credentials received from a user are verified by the authentication service.

At a block 415, the system 200 establishes a connection with the network interfacing application via an approval channel. At a decision block 420, the system verifies the authenticity of the received identity token. If the system determines that the identity token is inauthentic, the process 400 returns. If the system determines that the identity token is authentic, the process proceeds to a decision block 425. At decision block 425, the system determines whether a user associated with the identity token and the channel identifier is permitted to receive data on the channel associated with the received channel identifier. For example, for verifying that the user is permitted to receive data on the channel associated with the channel identifier, the system may compare the channel identifier, corresponding to a user identifier, to a list of channel identifiers associated with respective remote devices, determining that the user is verified if the channel identifier is listed in the list of channel identifiers. If the user is not authorized to receive data on the channel associated with the channel identifier, the process 400 returns.

If the identity token is authentic and the user is approved for receiving data on the channel associated with the channel identifier, the process proceeds to a block 430. At block 430, the system 200 transmits an indication via the approval channel to the network interfacing application, indicating that the network interfacing application is approved to receive data on the device-specific channel. The indication may include instructions and/or settings for connecting on the device-specific channel. At a block 435, the network interfacing application connects to the system on the device-specific channel. The system may transmit a push message to the remote device instructing the remote device to transmit requested data. The system may transmit the requested data over the connection established via the device specific channel.

### CONCLUSION

The disclosed system and method enable authenticated communications between a remote device and a web-interfacing application of a local device.

The disclosed system and method verify and authenticate a user for receiving data from a remote device, including, for example, data describing location information, such as for a location determination service.

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A tangible computer-readable storage medium containing instructions for performing a method of establishing authenticated communications between a remote device and a network interfacing application of a local device, the method comprising:
receiving from a network interfacing application of a local device a request for data from a remote device,
wherein the request includes an identity token associated with a user;
transmitting to the network interfacing application an indication for the network interfacing application to listen via an approval channel for an approval to receive data from the remote device;
identifying a channel associated with the user;
determining whether the identity token is authentic; and
when the identity token is determined to be authentic:
transmitting, via the approval channel, to the network interfacing application an indication that the network interfacing application is permitted to receive data from the remote device via the channel associated with the user;
receiving data from the remote device; and
transmitting the data received from the remote device to the network interfacing application of the local device via the channel associated with the user.

2. The tangible computer-readable storage medium of claim 1, wherein the data received from the remote device is transmitted to the network interfacing application via a WebSocket connection.

3. The tangible computer-readable storage medium of claim 1, wherein the network interfacing application is a web browser.

4. The tangible computer-readable storage medium of claim 1, wherein the data transmitted to the network interfacing application includes geographic location data.

5. The tangible computer-readable storage medium of claim 1, wherein identifying a channel associated with the user includes receiving a channel identifier from the network interfacing application of the local device.

6. The tangible computer-readable storage medium of claim 1, wherein determining whether the identity token is authentic includes:
transmitting the identity token to an authentication service; and
receiving an indication from the authentication service that the identity token is authentic.

7. The tangible computer-readable storage medium of claim 6, further comprising transmitting a push message to the remote device instructing the remote device to transmit the data received from the remote device.

8. The tangible computer-readable storage medium of claim 1, further comprising transmitting a push message to the remote device instructing the remote device to delete data at the remote device.

9. A method of establishing authenticated communications between a remote device and a network interfacing application of a local device, the method performed by a processor executing instructions stored in a memory, the method comprising:
receiving from a network interfacing application of a local device a request for data from a remote device,
wherein the request includes an identity token associated with a user;
transmitting to the network interfacing application an indication for the network interfacing application to listen via an approval channel for an approval to receive data from the remote device;
identifying a channel associated with the user;
determining whether the identity token is authentic; and
when the identity token is determined to be authentic:
transmitting, via the approval channel, to the network interfacing application an indication that the network interfacing application is permitted to receive data from the remote device via the channel associated with the user;
receiving data from the remote device; and
transmitting the data received from the remote device to the network interfacing application of the local device via the channel associated with the user.

10. The method of claim 9, wherein the data received from the remote device is transmitted to the network interfacing application via a WebSocket connection.

11. The method of claim 9, wherein the network interfacing application is a web browser.

12. The method of claim 9, wherein the data transmitted to the network interfacing application includes geographic location data.

13. The method of claim 9, wherein identifying a channel associated with the user includes receiving a channel identifier from the network interfacing application of the local device.

14. The method of claim 9, wherein determining whether the identity token is authentic includes:
transmitting the identity token to an authentication service; and
receiving an indication from the authentication service that the identity token is authentic.

15. The method of claim 14, further comprising transmitting a push message to the remote device instructing the remote device to transmit the data received from the remote device.

16. The method of claim 9, further comprising transmitting a push message to the remote device instructing the remote device to delete data at the remote device.

17. A system for facilitating authenticated communications between a remote device and a network interfacing application of a local device, the system comprising:
an authentication service, a device manager, and a device message relay, wherein:
the authentication service is configured to:
receive user credentials from a network interfacing application of a local device;
compare the received user credentials to stored user credentials;
when the received user credentials match the stored user credentials, generate an identity token;
transmit to the network interfacing application of the local device the identity token;
receive a request from the device message relay to verify an authenticity of the identity token,
wherein the request includes the identity token;
verify whether the identity token included in the request is authentic; and
transmit to the device message relay an indication of whether the identity token included in the request is authentic;
the device manager is configured to:
receive a request from the network interfacing application for a channel identifier associated with a remote device;
transmit to the network interfacing application a channel identifier associated with the remote device;
determine whether a user is permitted to receive data via a channel associated with the channel identifier;
receive from the device message relay a request that the device manager request that the remote device transmit data to be transmitted to the network interfacing application of the local device;
receive data from the remote device to be transmitted to the network interfacing application of the local device; and
transmit to the device message relay the data received from the remote device to be transmitted to the network interfacing application of the local device; and
the device message relay is configured to:
receive from the network interfacing application of the local device a request to receive data from the remote device via a channel associated with the channel identifier received by the network interfacing application from the device manager;
receive from the network interfacing application the identity token;
transmit the identity token to the authentication service for verifying whether the identity token is authentic;
transmit the channel identifier to the device manager for verifying whether the user is permitted to receive data via the channel associated with the channel identifier;
receive an indication that identity token is authentic;
receive an indication that the user is permitted to receive data on the channel associated with the channel identifier;
transmit to the network interfacing application of the local device an approval of transmitting data to the network interfacing application via the channel associated with the channel identifier; and
transmit to the network interfacing application of the local device, via the channel associated with the channel identifier, the data received from the remote device to be transmitted to the network interfacing application of the local device.

18. The system of claim 17, wherein the channel identifier is a user identifier identified by the authentication service based at least in part on the identity token.

19. The system of claim 17, wherein the device manager is further configured to transmit to the remote device a request that the remote device transmit data to be transmitted to the network interfacing application.

20. The system of claim 17, wherein the device manager is further configured to:
receive in the request for the channel identifier the identity token from the network interfacing application;
transmit a request to the authentication service for a user identifier associated with the identity token,
wherein the request includes the identity token;
receive the user identifier from the authentication service;
compare the user identifier to user identifiers in a channel user mapping;
based on the comparison, identify a channel identifier associated with the user identifier; and
transmit the channel identifier to the network interfacing application of the local device.
